(19) United States
(12) Patent Application Publication
(10) Pub. No.: US 2022/0407148 A1
(43) Pub. Date: Dec. 22, 2022

(54) BATTERY SYSTEM INCLUDING A SELF-REGULATING COOLING SYSTEM

(71) Applicant: GM Global Technology Operations LLC, Detroit, MI (US)

(72) Inventors: Chih-hung Yen, Bloomfield Hills, MI (US); Taeyoung Han, Bloomfield Hills (KR); Kuo-huey Chen, Troy, MI (US); Bahram Khalighi, Salt Lake City, UT (US)

(21) Appl. No.: 17/350,350

(22) Filed: Jun. 17, 2021

(51) Int. Cl. H01M 10/6569; H01M 10/613; H01M 10/6557; H01M 10/6568

(52) U.S. Cl. CPC H01M 10/6569; H01M 10/613; H01M 10/6557; H01M 10/6568

(57) ABSTRACT

A battery system includes a power cell and a heat exchanger abutting the power cell. The heat exchanger includes a cooling medium reservoir, a heat exchange member, and a wicking structure disposed between the cooling medium reservoir and the heat exchange member. The wicking structure provides a fluid pathway from the cooling medium reservoir to the heat exchange member and from the heat exchange member to the cooling medium reservoir.

### INTRODUCTION

The subject disclosure relates to battery systems and, more particularly, to a battery system including a self-regulating cooling system.

Power systems that include batteries generate heat when placed under load. Heat generation is related to battery power. That is, the more power provided by the battery, the greater the amount of heat created. Heat may have a detrimental effect on battery efficiency and/or battery life. Accordingly, removing the heat provides a benefit to battery operation. In some cases, fans are directed at the battery to create an air flow which acts as a heat exchange medium. While effective at certain temperatures, larger batteries, such as those used to power vehicles, generate more heat than can be efficiently carried away by the airflow.

Other cooling systems may employ a cooling fluid that is pumped, in a heat exchange relationship, through the battery. The cooling fluid typically passes through a heat exchanger that is arranged adjacent to battery cells. Such systems require a device, such as a pump, for motivating the cooling fluid through the heat exchanger. The pump is either run from the battery or is provided with a separate source of power. In either case, the need for the pump detracts from an overall efficiency of the battery. Accordingly, it is desirable to provide a system for removing heat from a battery that can accommodate larger heat demands without detracting from an overall efficiency of the power system.

### SUMMARY

Disclosed is a battery system including a power cell and a heat exchanger abutting the power cell. The heat exchanger includes a cooling medium reservoir, a heat exchange member, and a wicking structure disposed between the cooling medium reservoir and the heat exchange member. The wicking structure provides a fluid pathway from the cooling medium reservoir to the heat exchange member and from the heat exchange member to the cooling medium reservoir.

In addition to one or more of the features described herein a support member extends between the cooling medium reservoir and the heat exchange member, the wicking structure being arranged on the support member.

In addition to one or more of the features described herein the support member is formed from aluminum.

In addition to one or more of the features described herein the wicking structure comprises a screen.

In addition to one or more of the features described herein the screen includes multiple screen segments extending between the cooling medium reservoir and the heat exchange member.

In addition to one or more of the features described herein a gap is defined between adjacent ones of the multiple screen segments.

In addition to one or more of the features described herein the gap defines a cooling medium return path.

In addition to one or more of the features described herein the wick structure is formed from sintered copper particles.

In addition to one or more of the features described herein another power cell is arranged adjacent the power cell, the heat exchange member being arranged between the power cell and the another power cell.

In addition to one or more of the features described herein the heat exchanger includes a first heat exchanger abutting the power cell and a second heat exchanger abutting the another power cell.

In addition to one or more of the features described herein an insulating member is arranged between the first heat exchanger and the second heat exchanger.

In addition to one or more of the features described herein a cooling medium is arranged in the cooling medium reservoir.

In addition to one or more of the features described herein the cooling medium comprises one of water and ammonia.

In addition to one or more of the features described herein the heat exchange member comprises one of a fin type heat exchange member and a cold plate heat exchange member.

Also disclosed is a method of removing heat from a battery system including placing a heat exchanger including a cooling medium reservoir against a power cell of a battery, flowing a cooling medium from the cooling medium reservoir toward a heat exchange member through a wicking structure, absorbing heat into the cooling medium, and removing the heat from the cooling medium in the heat exchange member.

In addition to one or more of the features described herein flowing the cooling medium includes urging the cooling medium through the wicking structure with a capillary force.

In addition to one or more of the features described herein placing the heat exchanger includes positioning a first heat exchanger against a first power cell and positioning a second heat exchanger against a second power cell, the first and second heat exchangers being disposed between the first and second power cells.

In addition to one or more of the features described herein insulating an interface between the first heat exchanger and the second heat exchanger.

In addition to one or more of the features described herein applying a compressive force to the first and second heat exchangers through the first and second power cells.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

FIG. 1 is a glass view of a battery system including a self-regulating cooling system, in accordance with a non-limiting example;

FIG. 2 is a perspective view of a heat exchanger of the self-regulating cooling system, in accordance with a non-limiting example; and

FIG. 3 is an end view of the battery system including the self-regulating cooling system, in accordance with a non-limiting example.

### DETAILED DESCRIPTION

The following description is merely exemplary in nature and is not intended to limit the present disclosure, its application or uses. It should be understood that throughout the drawings, corresponding reference numerals indicate like or corresponding parts and features.

A battery system, in accordance with a non-limiting example, is indicated generally at 10 in FIG. 1. Battery system 10 includes a first power cell 14 and a second power cell 16. Each power cell 14, 16 is designed to produce electrical energy. Power cells 14 and 16 may take on a variety of forms including lead-acid cells, lithium-ion cells, and the like. A heat exchange system 20 is disposed between first power cell 14 and second power cell 16. As will be detailed more fully herein, heat exchange system 20 operates to remove heat produced by first power cell 14 and second power cell 16.

Heat exchange system 20 includes a first heat exchanger 24 associated with first power cell 14 and a second heat exchanger 26 associated with second power cell 16. First and second heat exchangers 24 and 26 are separated by a layer of thermal insulation 30 and thermally coupled to a heat exchange member 38 positioned on first and second power cells 14 and 16. Heat exchange member 38 may take on various forms such as a fin-type, a fin and tube-type, a cold plate, and the like. Thermal insulation 30 is sandwiched between first and second heat exchangers 24 and 26. Thermal insulation 30 reduces thermal transfer between first and second heat exchangers 24 and 26.

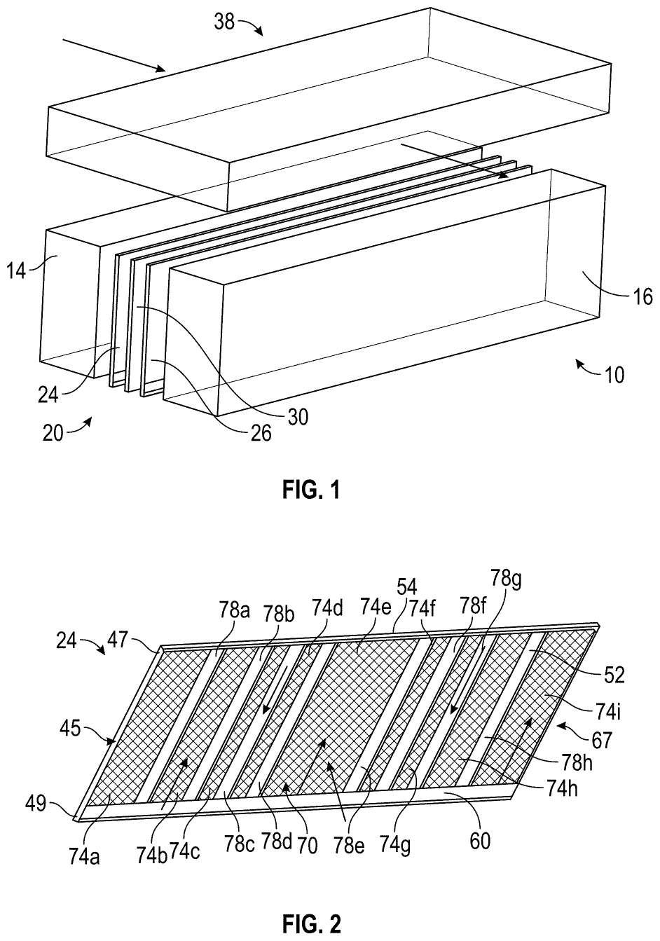

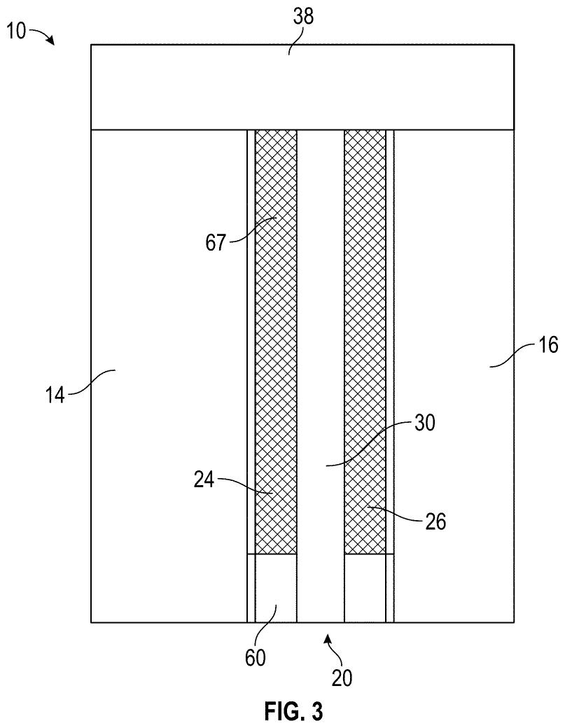

Reference will now follow to FIGS. 2 and 3 in describing first heat exchanger 24 with an understanding that second heat exchanger 26 includes similar structure. First heat exchanger 24 includes a support member 45 having a first or upper end 47 and a second or lower end 49. First end 47 is thermally connected to heat exchange member 38. Support member 45 includes a first substantially planar surface 52 and an opposing second substantially planar surface 54. Second substantially planar surface 54 abuts an outer surface (not separately labeled) of first power cell 14. Support member 45 may be formed from a wide array of thermally conductive materials such as aluminum, copper, steel, or the like.

In a non-limiting example, first heat exchanger 24 includes a cooling medium reservoir 60 located at second end 49 and a wicking structure 67 disposed on first planar surface 52. Cooling medium reservoir 60 contains a cooling medium such as water, ammonia, and the like. Wicking structure 67 is fluidically exposed to the cooling medium and thermally connected to heat exchange member 38. Wicking structure 67 may take on a variety of forms such as, in the non-limiting example shown, a screen 70 or a layer of sintered copper. However other thermally conductive materials may also be employed. Further, wicking structure 67 may include a hydrophilic layer that promotes a wicking of the cooling medium from cooling medium reservoir 60 toward heat exchange member 38.

In a non-limiting example, screen 70 is formed from multiple screen segments 74a-74i extending across first substantially planar surface 52. Screen segments 74a-74i are separated by gaps 78a-78h that extend between heat exchange member 38 and cooling medium reservoir 60. In a non-limiting example, when under load, (e.g., being used to produce power) heat generated by first and second power cells 14 and 16 flows into corresponding ones of first heat exchanger 24 and second heat exchanger 26. The heat causes the cooling medium in cooling medium reservoir 60 to flow through wicking structure 67 toward heat exchange member 38. More specifically, the heat from, for example, first power cell 14 may cause the cooling medium to evaporate and flow upwardly. Upon reaching heat exchange member 38, the cooling medium may lose heat, liquify, and return to cooling medium reservoir 60 via gaps 78a-78h under force of gravity.

The amount and rate of flow of the cooling medium is proportional to the amount of heat produced by each power cell 14. If, for example, one of the first and second power cells 14, 16 undergoes a thermal runaway, any thermal energy released would cause all the fluid inside the wicking structure 67 and cooling medium reservoir to evaporate or undergo a “dry-out” condition. In such a case, heat exchange system 20 would effectively turn into an insulation layer that disrupts heat transfer to the other of first and second power cells 14 and 16 to stem a propagation of the thermal runaway into additional and/or neighboring power cells. As such, heat exchange system 20 is self-regulating. Further the use of a wicking medium and a return flow path negates the need for powered pumps or other structure that may reduce an overall efficiency of the battery system. Further, the particular design of the heat exchange system allows power cells to be compressed together, such as shown in FIG. 3 so as to increase heat exchange efficacy and reduce an overall footprint of the battery system.

While the above disclosure has been described with reference to non-limiting examples, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof Therefore, it is intended that the present disclosure not be limited to the particular embodiments disclosed, but will include all embodiments falling within the scope thereof.

What is claimed is:

1. A battery system comprising:
a power cell; and
a heat exchanger abutting the power cell, the heat exchanger including a cooling medium reservoir, a heat exchange member, and a wicking structure disposed between the cooling medium reservoir and the heat exchange member, the wicking structure providing a fluid pathway from the cooling medium reservoir to the heat exchange member and from the heat exchange member to the cooling medium reservoir.

2. The battery system according to claim 1, further comprising: a support member extending between the cooling medium reservoir and the heat exchange member, the wicking structure being arranged on the support member.

3. The battery system according to claim 2, wherein the support member is formed from aluminum.

4. The battery system according to claim 2, wherein the wicking structure comprises a screen.

5. The battery system according to claim 4, wherein the screen includes multiple screen segments extending between the cooling medium reservoir and the heat exchange member.

6. The battery system according to claim 5, further comprising: a gap defined between adjacent ones of the multiple screen segments.

7. The battery system according to claim 6, wherein the gap defines a cooling medium return path.

8. The battery system according to claim 4, wherein the wick structure is formed from sintered copper particles.

9. The battery system according to claim 1, further comprising: another power cell arranged adjacent the power cell, the heat exchange member being arranged between the power cell and the another power cell.

10. The battery system according to claim 9, wherein the heat exchanger includes a first heat exchanger abutting the power cell and a second heat exchanger abutting the another power cell.

11. The battery system according to claim 10, further comprising: an insulating member arranged between the first heat exchanger and the second heat exchanger.

12. The battery system according to claim 1, further comprising: a cooling medium arranged in the cooling medium reservoir.

13. The battery system according to claim 12, wherein the cooling medium comprises one of water and ammonia.

14. The battery system according to claim 1, wherein the heat exchange member comprises one of a fin type heat exchange member and a cold plate heat exchange member.

15. A method of removing heat from a battery system comprising:
placing a heat exchanger including a cooling medium reservoir against a power cell of a battery;
flowing a cooling medium from the cooling medium reservoir toward a heat exchange member through a wicking structure;
absorbing heat into the cooling medium; and
removing the heat from the cooling medium in the heat exchange member.

16. The method of claim 15, wherein flowing the cooling medium includes urging the cooling medium through the wicking structure with a capillary force.

17. The method of claim 15, wherein placing the heat exchanger includes positioning a first heat exchanger against a first power cell and positioning a second heat exchanger against a second power cell, the first and second heat exchangers being disposed between the first and second power cells.

18. The method of claim 17 further comprising: insulating an interface between the first heat exchanger and the second heat exchanger.

19. The method of claim 17, further comprising: applying a compressive force to the first and second heat exchangers through the first and second power cells.

20. The method of claim 17, further comprising: insulating an interface between the first heat exchange member and the second heat exchange member.
